(19) United States
(12) Patent Application Publication
(10) Pub. No.: US 2004/0030936 A1
(43) Pub. Date: Feb. 12, 2004

(54) Notebook computer having temperature adjustment function

(76) Inventors: Ming Chang Wang, Taoyuan City (TW); Chih Wen Liu, Taipei (TW); Wen Hsiung Chang, Yunlin Hsien (TW); Jung Kuey Lee, Taipei (TW); Pao Chang Lin, Hsinchuang City (TW)

Correspondence Address: BIRCH STEWART KOLASCH & BIRCH, PO BOX 747, FALLS CHURCH, VA, 22040-0747, US

(21) Appl. No.: 10/213,095

(22) Filed: Aug. 7, 2002

(51) Int. Cl. G06F 1/26

(52) U.S. Cl. 713/300

(57) ABSTRACT

A notebook computer having a temperature adjustment function for a microprocessor includes a clock generator, a thermal sensor, an I/O controller, a bus switch, and a voltage regulator. The thermal sensor and the I/O controller are connected between the microprocessor and the clock generator. The bus switch is connected between the microprocessor and the I/O controller and with the voltage regulator. When the surface temperature of the microprocessor exceeds a predetermined temperature, the system BIOS will immediately issue a command to the I/O controller to automatically lower the external clock and the power source voltage level of the microprocessor. Thereby, the power consumption of the microprocessor can be reduced to lower the surface temperature.

### FIELD OF THE INVENTION

The present invention relates to a notebook computer having a temperature adjustment function for a microprocessor of the notebook computer and, more particularly, to a notebook computer just allowing the microprocessor temperature within a predetermined temperature range so that the system will not crash or burn down due to overheat of the microprocessor.

### BACKGROUND OF THE INVENTION

In general, a thermal control device of a computer aims at the microprocessor temperature. As shown in FIGS. 1 and 2, a temperature alarm unit 10 is disposed below a microprocessor 20 to directly detect the temperature of the microprocessor 20. A thermal sensor 30 is disposed in the temperature alarm unit 10 and connected to a fan rotation speed control circuit 70, which can change the rotation speed of a cooling fan 60 of the microprocessor 20 due to the temperature variation of the microprocessor 20, hence preventing the microprocessor 20 from overheat.

Or the temperature alarm unit 10 further includes a comparator 50 connected to the thermal sensor 30. The output terminal of the comparator 50 is connected to a speaker driving circuit 40. The thermal sensor 30 generates different voltages according to different temperatures. The voltages will be compared with a preset voltage so as to let a speaker SP generates alarms.

In the prior art, the fan rotation speed control circuit, the comparator, and the speaker drive circuit are used to avoid overheat of the microprocessor. However, when in use, there are still some unexpected problems to cause the system crash or burn down.

### SUMMARY OF THE INVENTION

Accordingly, one object of the present invention is to propose a notebook computer whose microprocessor temperature is kept to fall within a predetermined range in order to prevent the microprocessor from overheat.

To achieve the above object, the present invention proposes a notebook computer having a thermal sensor and an I/O controller connected between a THERMDA pin and a THERMDC pin of the microprocessor, a clock generator and a bus switch connected between VID[0 . . . 4] pins of the microprocessor, a PM-GMUXSEL pin, and AC-VID[0 . . . 4] pins of the I/O controller. Further, the VR-VID[0 . . . 4] pins of the bus switch are connected to a voltage regulator. When the surface temperature of the microprocessor arrives at a predetermined value, the system BIOS will immediately issue a command to the I/O controller to automatically lower the external clock and power source voltage (VCC-CORE) level of the microprocessor. Thereby, the power consumption of the microprocessor can be reduced so as to lower the temperature of the microprocessor itself.

Another object of the present invention is to provide a notebook computer having adjusted the microprocessor temperature thereof within a predetermined range by controlling the power consumption of the microprocessor.

The various objects and advantages of the present invention will be more readily understood from the following detailed description when read in conjunction with the appended drawing, in which:

### BRIEF DESCRIPTION OF THE DRAWINGS

FIG. 1 is a schematic diagram of a conventional thermal control device;

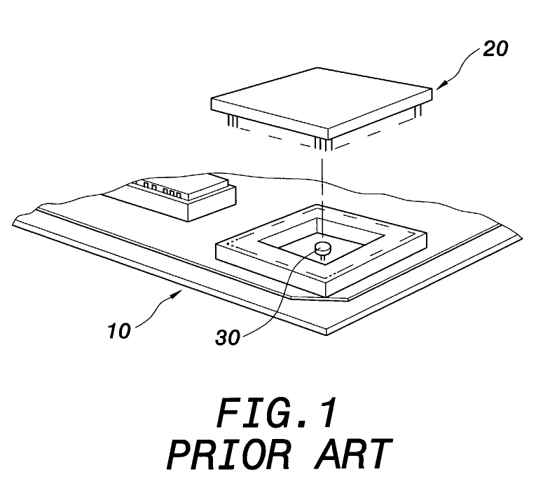

FIG. 2 is a circuit diagram of a conventional thermal control device; and

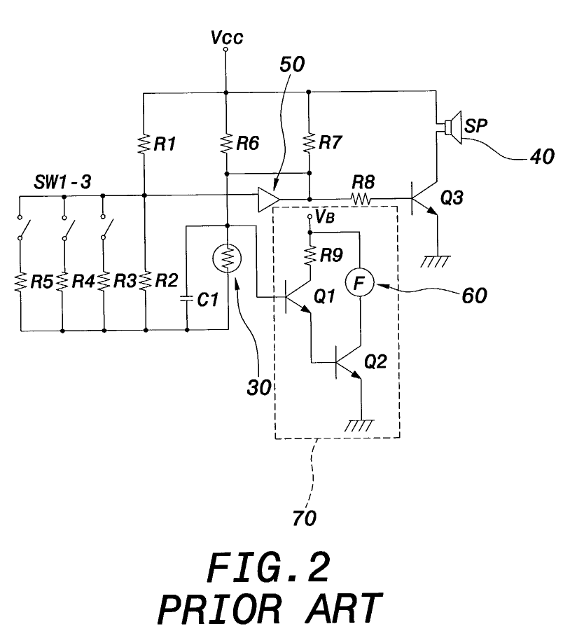

FIG. 3 is a circuit block diagram of the present invention.

### DETAILED DESCRIPTION OF THE PREFERRED EMBODIMENTS

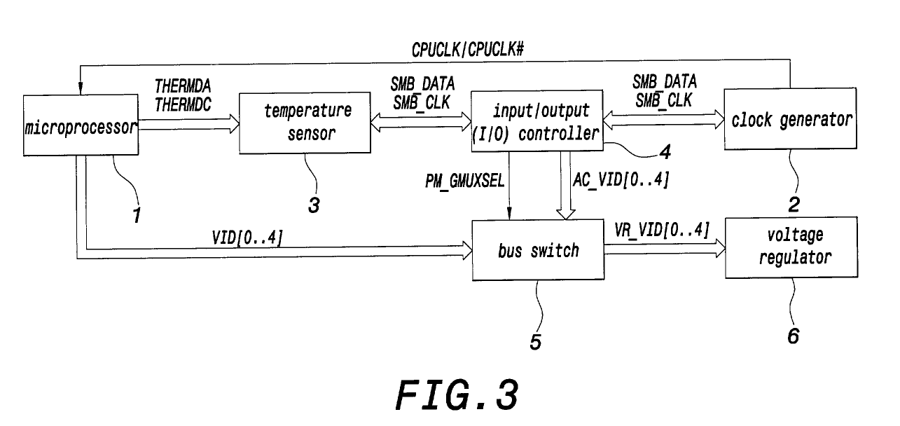

As shown in FIG. 3, a notebook computer having a temperature adjustment function for a microprocessor according to the present invention includes a microprocessor 1, a clock generator 2, a thermal sensor 3, an I/O controller 4, a bus switch 5, and a voltage regulator 6.

In this embodiment, the microprocessor 1 is an Intel Pentium 4 microprocessor.

A CPUCLK/CPUCLK# pin of the clock generator 2 is connected with a BCLK0/BCLK1 pin (not shown) of the microprocessor 1 to provide an external clock to the microprocessor 1. The thermal sensor 3 is connected with a THERMDA pin and a THERMDC pin of the microprocessor 1 to detect the surface temperature of the microprocessor 1. The I/O controller 4 is connected with a SMB-DATA pin and a SMB-CLK pin of the clock generator 2 and a SMB-DATA pin and a SMB-CLK pin of the thermal sensor 3, respectively. The I/O controller 4 receives a command from the system BIOS when the thermal sensor 3 detects that the surface temperature of the microprocessor 1 exceeds a predetermined temperature. The bus switch 5 is connected with VID[0 . . . 4] pins of the microprocessor 1 and a PM-GMUXSEL pin and AC-VID[0 . . . 4] pins of the I/O controller 4, respectively. The voltage regulator 6 is connected with VR-VID[0 . . . 4] pins of the bus switch 5. The voltage regulator 6 adjusts the power source voltage (VCC-CORE) level of the microprocessor 1 according to an output signal of the bus switch 5.

When the thermal sensor 3 detects that the surface temperature of the microprocessor 1 exceeds the predetermined temperature, the system BIOS immediately issues a command to the I/O controller 4 to perform two following steps of:

1. lowering down the external clock to the microprocessor, for example, from 100 MHz to 1 to 90 MHz; and

2. lowering down the power source voltage (VCC-CORE) level of the microprocessor 1, for example, 1.5V to 1.45V.

The relationship between the external clock and the power source voltage level of the microprocessor 1 is as follows.

| External Clock | Power Source Voltage Level(VCC-CORE) |
|---|---|
| 100 MHz | 1.5 V |
| 90 MHz | 1.45 V |
| 85 MHz | 1.4 V |

When the PM-GMUXSEL pin of the I/O controller 4 is at the low level, the right of adjusting the power source voltage level is issued to the microprocessor 1. Contrarily, when the PM-GMUXSEL pin of the I/O controller 4 is at the high level, the right of adjusting the power source voltage level is issued to the I/O controller 4.

Thereby, the power consumption of the microprocessor 1 can be lowered to reduce the surface temperature of the microprocessor 1.

To sum up, through the present invention, the surface temperature of the microprocessor in the notebook computer is controlled to be within a predetermined voltage range, hence preventing the system from crashing or burning down due to microprocessor overheat.

Although the present invention has been described with reference to the preferred embodiment thereof, it will be understood that the invention is-not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A notebook computer having a temperature adjustment function for a microprocessor thereof, comprising:
a clock generator connected with said microprocessor for providing an external clock to said microprocessor;
a thermal sensor for detecting the temperature of said microprocessor;
a bus switch connected with said microprocessor;
a voltage regulator connected with said bus switch for adjusting a power source voltage level of said microprocessor according to an output signal of said bus switch; and
an I/O controller respectively connected with said thermal sensor, said clock generator, and said bus switch;
wherein while said thermal sensor senses the temperature of said microprocessor exceeds a predetermined temperature, said external clock and said operating voltage level are lowered down so as to lower the power consumption of said microprocessor to reduce the temperature thereof.

2. The notebook computer as claimed in claim 1, wherein said microprocessor is an Intel Pentium 4 microprocessor.

3. The notebook computer as claimed in claim 1, wherein said I/O controller comprises a PM-GMUXSEL pin connected with said bus switch for issuing a right of adjusting the power source voltage level to said I/O controller or said microprocessor.

4. The notebook computer as claimed in claim 3, wherein when said PM-GMUXSEL pin of said I/O controller is at a low level, said right of adjusting the power source voltage level is issued to said microprocessor.

5. The notebook computer as claimed in claim 3, wherein when said PM-GMUXSEL pin is at a high level, the right of adjusting the power source voltage level is issued to said I/O controller.
